(19) United States
(12) Patent Application Publication
(10) Pub. No.: US 2010/0232400 A1
(43) Pub. Date: Sep. 16, 2010

(54) VIRTUALIZING SINGLE RADIO FOR MULTIPLE WIRELESS INTERFACES IN HOME MESH NETWORK

(75) Inventors: Abhishek Patil, San Diego, CA (US); Xiangpeng Jing, San Diego, CA (US); Aixin Liu, San Diego, CA (US); Djung N. Nguyen, San Diego, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignees: Sony Corporation, Tokyo (JP); Sony Electronics Inc., Park Ridge, NJ (US)

(21) Appl. No.: 12/402,433

(22) Filed: Mar. 11, 2009

(51) Int. Cl. H04B 7/212

(52) U.S. Cl. 370/337

(57) ABSTRACT

An embodiment is a technique to virtualize a single physical radio for multiple wireless interfaces. A physical wireless network interface is configured into a first virtual access point (VAP) and a second VAP on a device using a single radio transceiver in a home mesh network. The first and second VAPs operate on first and second channels corresponding to first and second modes, respectively, in a time division multiple access (TDMA) mode.

### TECHNICAL FIELD

The presently disclosed embodiments are directed to the field of wireless communication, and more specifically, to mesh network.

### BACKGROUND

A wireless network can provide a flexible data communication system that can either replace or extend a wired network. Using radio frequency (RF) technology, wireless networks transmit and receive data over the air through walls, ceilings and even cement structures without wired cabling. For example, a wireless local area network (WLAN) provides all the features and benefits of traditional LAN technology, such as Ethernet and Token Ring, but without the limitations of being tethered together by a cable. This provides greater freedom and increased flexibility.

Currently, a wireless network operating in accordance with the Institute of Electrical and Electronic Engineers (IEEE) 802.11 Standard (e.g., IEEE Std. 802.11a/b/g/n) may be configured in one of two operating modes: infrastructure mode and ad hoc mode. In some special networks, it would be desirable for a node to have multiple wireless interfaces to other nodes. One simple way to support the multiple wireless interfaces is to use multiple radios on a single device. However, use of multiple RF circuits for multiple radios has a number of drawbacks. First, it is expensive to include multiple RF circuits. Second, due to cross-radio interferences, constraints may have to be imposed on the RF design, limiting design flexibility. Third, multiple RF circuits may occupy more space on the device.

### SUMMARY

One disclosed feature of the embodiments is a method and apparatus to virtualize a single physical radio for multiple wireless interfaces. A physical wireless network interface is configured into a first virtual access point (VAP) and a second VAP on a device using a single radio transceiver in a home mesh network. The first and second VAPs operate on first and second channels corresponding to first and second modes, respectively, in a time division multiple access (TDMA) mode.

### BRIEF DESCRIPTION OF THE DRAWINGS

Embodiments may best be understood by referring to the following description and accompanying drawings that are used to illustrate embodiments. In the drawings.

FIG. 1 is a diagram illustrating a system of a three-tier wireless ad hoc home mesh network (WHMN) according to one embodiment.

FIG. 2 is a diagram illustrating a single radio device within a WHMN according to one embodiment.

FIG. 3 is a diagram illustrating a single radio interface virtualizer according to one embodiment.

FIG. 4 is a diagram illustrating a super frame according to one embodiment.

FIG. 5 is a diagram illustrating a queue maintenance module according to one embodiment.

FIG. 6 is a flowchart illustrating a process to virtualize a single radio for multiple interfaces according to one embodiment.

FIG. 7 is a flowchart illustrating a process to configure a physical wireless network interface according to one embodiment.

FIG. 8 is a flowchart illustrating a process to operate first and second virtual access points (VAP) according to one embodiment.

FIG. 9 is a flowchart illustrating a process to transmit or receive a frame according to one embodiment.

### DETAILED DESCRIPTION

One disclosed feature of the embodiments is a technique to virtualize a single physical radio for multiple wireless interfaces. A physical wireless network interface is configured into a first virtual access point (VAP) and a second VAP on a device using a single radio transceiver in a home mesh network. The first and second VAPs operate on first and second channels corresponding to first and second modes, respectively, by switching the physical radio parameters in a time division multiple access (TDMA) mode. Each virtualized network interface may be configured to operate in different (wireless) modes and may use different channels.

In the following description, numerous specific details are set forth. However, it is understood that embodiments of the invention may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. The beginning of a flowchart may be indicated by a START label. The end of a flowchart may be indicated by an END label. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

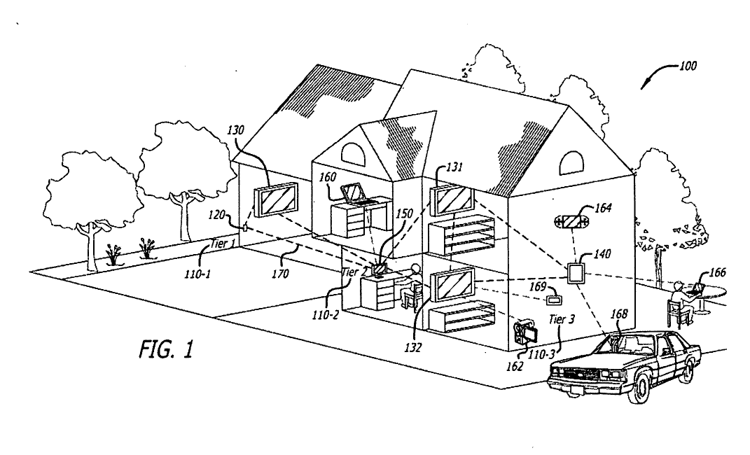

FIG. 1 is a diagram illustrating a system of a three-tier wireless ad hoc home mesh network (WHMN) according to one embodiment.

Multi-tier wireless home mesh network 100 (hereinafter referred to as “WHM network” or “WHMN” 100) comprises a collection of nodes that operate as a decentralized, wireless home mesh network with multiple (N≧1) sub-networks 110₁-110_{N} (hereinafter singularly referred to as “tiers”) that are responsible for different functions within WHM network 100. Hence, mostly every node of WHM network 100 is configured to forward data to other nodes and is assigned to a specific tier based on its performance capabilities and power constraints. The assignment of a node to a tier is a decision based on performance capabilities of the node, whereas routing decisions are made by the nodes based on the network connectivity and the ability to forward data by that particular node.

For instance, one embodiment of WHM network 100 features a hierarchical architecture comprising three (3) tiers that are assigned based on the capabilities of the node. A first tier (“tier 1”) 110₁ is responsible for establishing and controlling access to an external network such as the Internet. For example, first tier 110₁ may resemble a traditional Internet connection via a cable or direct subscriber line (DSL) connection or 3G/WiMax/Outdoor mesh. As illustrated, first tier 110₁ comprises a first node 120, which is commonly referred to as a “gateway node.” Gateway node 120 may include, but is not limited or restricted to a cable or DSL modem, a wireless router or bridge, and the like. Although not shown, multiple gateway nodes may be present within WHM network 100 in order to provide multiple communication paths to external network(s).

A second tier (“tier 2”) 110₂ of WHM network 100 may represent a wireless network backhaul that interconnects various stationary (fixed-location) wireless nodes such as stationary (fixed-location) electronics devices adapted for communicating over a wireless communication medium such as, for example, radio frequency (RF) waves. As described herein, an “electronic device” may be stationary or mobile. A “stationary electronics device” includes, but is not limited or restricted to: a flat-panel television (130, 131, and 132), a gaming console (140), desktop computer (150), or any other device that is usually stationary and is electrically coupled to an AC power outlet. Hence, stationary electronics devices are not subject to power constraints that are usually present in mobile nodes where power usage is minimized to extend battery life between recharges.

A third tier (“tier 3”) 110₃ of WHM network 100 may include links between a wireless node belonging to second tier 110₂ and one or more mobile nodes (160, 162, 164, 166, 168 & 169). A “mobile node” may include any battery powered electronics device with wireless connectivity including, but is not limited to a laptop computer, handheld device (e.g., personal digital assistant, ultra mobile device, cellular phone, portable media player, wireless camera, remote control, etc.) or any non-stationary consumer electronics devices. Since mobile nodes normally have resource constraints (e.g., limited power supplies, limited processing speeds, limited memory, etc.), third tier 110₃ may provide reduced network services. In one embodiment, mobile nodes of WHM network 100 may act as a slave or child connecting directly to a tier-2 node, which may further limit their functionality within WHM network 100.

Table 1 summarizes a multi-tier, wireless home mesh network architecture, categorization by potential network characteristics, tier node descriptions and traffic type that is prevalent over WHM network 100.

TABLE 1
multi-tier wireless home mesh network scenario

| | | Characteristics | Examples |
|---|---|---|---|
| Network | Dimension | ~50 × 60 sq ft; | House |
| | | 1-2 stories or high- | Apartment building |
| | | rising building | Business |
| | Node Number | Tier 2 - 3~10; | 2 TVs, 1 desktop |
| | | Tier 3 - 5~20 | computer, 1 PS3; 2 |
| | | | laptops, 4 mobile |
| | | | phones, 4 media |
| | | | players, . . . |
| | Distribution | Indoor, 3D, Non- | Uniformly |
| | | LOS, link distance | distributed Tier-2 |
| | | 15~60 ft | nodes, clustered |
| | | | Tier 3 |
| Node | Tier 1 | Usually one or two | Cable/DSL modem, |
| Type (per | | Tier 1 nodes | WiMax/3G, |
| Tier | | | Outdoor Mesh |
| Network) | | | |
| | Tier 2 | Fixed location, | TV, desktop |
| | | power-sufficient | computer, gaming |
| | | (TX power | console (e.g. PS3), |
| | | 100 mW-1 W) | etc. |
| | Tier 3 | Mobile, power- | Laptop, mobile |
| | | limited (TX power | phone, portable |
| | | 1-100 mW) | media player, |
| | | | wireless camera, |
| | | | remote |
| Traffic | HD video | ~30 Mbps | 1080 p/i, 720 p/i, |
| | streaming | compressed | 480 p/i quality HD |
| | | | videos |
| | SD Video/Audio | ~100k-1 Mbps | Internet video clip |
| | streaming | video, 32k-256 kbps | (e.g. YouTube ®), |
| | | audio | webcam output, |
| | | | mp3 audio, voice |
| | Data | Bursty | http type data (web |
| | | transmission, | browsing) |
| | | ~20 Mbps for | |
| | | certain user | |
| | | satisfaction | |

As indicated by Table 1, WHM network 100 is distinct from conventional mesh-network solutions because WHM network 100 is directed to consumer electronics (CE) devices and video-centric applications. Based on the traffic indicated in Table 1, which may include high-definition (HD) video, audio clips and video clips, as well as user data, wireless NICs may be incorporated within some of the stationary nodes of the WHM network 100. For example, by multiplexing one flow of compressed HD video, four Internet video sessions plus four audio/video sessions and some intermittent http data traffic, the load on the backhaul link 170 is approximately 60 megabits per second for TCP/UDP type traffic, which may require at least 100 megabits per second of raw radio support considering media access control (MAC) layer efficiency. According to this example, the tier 2 nodes might require an 802.11n type radio (e.g., at 5 GHz band) to meet such a bandwidth requirement.

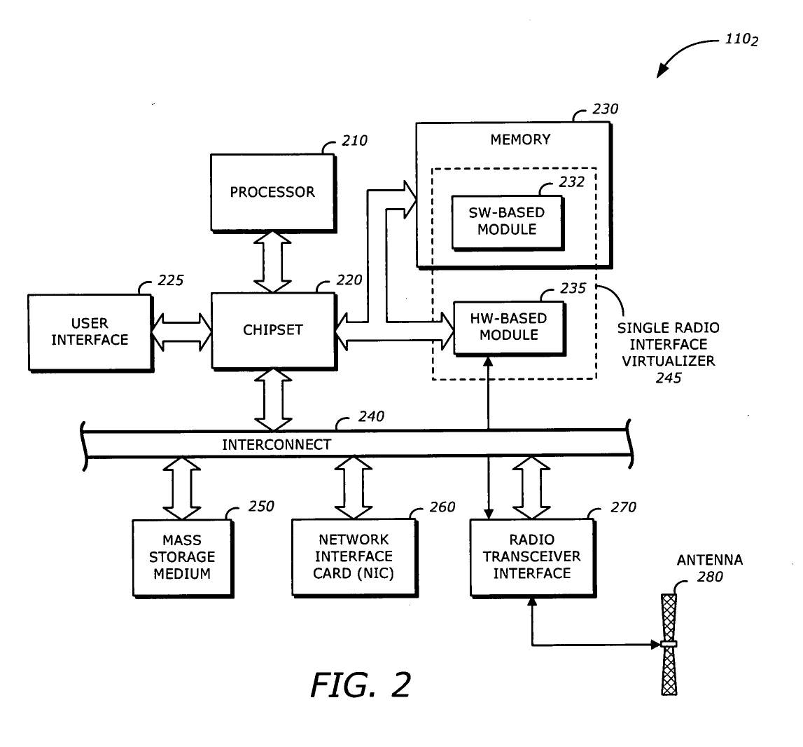

FIG. 2 is a diagram illustrating the single radio device 110₂ within a WHMN according to one embodiment. The single radio device 110₂ may be a tier-2 device in the WHMN. It may include a processor 210, a chipset 220, a memory 230, a user interface 225, an interconnect 240, a single radio interface virtualizer 245, a mass storage medium 250, a network interface card (NIC) 260, a radio transceiver interface 270, and an antenna 280. The single radio device may include more or less than the above components.

The processor 210 may be a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The chipset 220 provides control and configuration of memory and input/output (I/O) devices such as user interface 225, the single radio interface virtualizer 245, the memory 230, the mass storage medium 250, the NIC 260, and the radio transceiver interface 270. The chipset 220 may integrate multiple functionalities such as I/O controls, graphics, media, host-to-peripheral bus interface, memory control, power management, etc.

The single radio interface virtualizer 245 virtualizes a physical network interface (e.g., the radio transceiver interface 270) so that the physical network interface may operate as multiple interfaces (optionally) with different properties sharing the same radio physical resource (e.g., transmit and receive functions). The virtualizer 245 creates an abstraction of multiple interfaces although in reality only a single physical radio is used. The abstraction is presented to the operating system or other layers. It may include a software (SW)-based module 232 and a hardware (HW)-based module 235. It is noted that the single radio interface virtualizer 245 may include more or less than the above components. For example, it may include only the SW-based module 232 or only the HW-based module 235. The single radio interface virtualizer 245 performs interface virtualization using a single radio through the use of multiple channels. The SW-based module 232 may include programs, instructions, or functions to carry out part or all of the operations for the single radio AP virtualization. The HW-based module 235 may include circuits, logic, devices, or firmware components to carry out part or all of the operations for the single radio interface virtualization. The HW-based module 235 may interact with the radio transceiver interface 270 for various control and other operations. The HW-based module 235 may also be a part of the radio transceiver interface 270.

The memory 230 stores system code and data. The memory 230 is typically implemented with dynamic random access memory (DRAM), static random access memory (SRAM), or any other types of memories including those that do not need to be refreshed, including read only memory (ROM), flash memories. In one embodiment, the memory 230 may have the SW-based module 232 that performs the functions of virtualization of interfaces using a single radio. The user interface 225 may include circuits and functionalities that provides interface to a user. This may include display control, entry device control, remote control, etc. The entry device or devices may include keyboard, mouse, trackball, pointing device, stylus, or any other appropriate entry device. The display device may be a television (TV) set, a display monitor, or a graphic output device. The display type may include any display type such as high definition TV (HDTV), cathode ray tube (CRT), flat panel display, plasma, liquid crystal display (LCD), etc.

The interconnect 240 provides an interface for the chipset 220 to communicate with peripheral devices such as the mass storage medium 250 and the NIC 260. The interconnect 240 may be point-to-point or connected to multiple devices. For clarity, not all the interconnects are shown. It is contemplated that the interconnect 240 may include any interconnect or bus such as Peripheral Component Interconnect (PCI), PCI Express, Universal Serial Bus (USB), and Direct Media Interface (DMI), etc.

The mass storage medium 250 may store archive information such as code, programs, files, data, and applications. The mass storage interface may include small system computer interface (SCSI), serial SCSI, Advanced Technology Attachment (ATA) (parallel and/or serial), Integrated Drive Electronics (IDE), enhanced IDE, ATA Packet Interface (ATAPI), etc. The mass storage medium 250 may include compact disk (CD) read-only memory (ROM), memory stick, memory card, smart card, digital video/versatile disc (DVD), floppy drive, hard drive, tape drive, and any other electronic, magnetic or optic storage devices. The mass storage device or medium 250 provides a mechanism to read machine-accessible media. The NIC 260 provides interface to the various network layers in the WHMN such as the TCP/IP layer and the MAC layer.

The radio transceiver interface 270 may include analog and digital circuits to perform radio communication interface. It is connected to the antenna 280 to receive and transmit radio frequency (RF) signals. It may include analog and digital circuitries for fast down-conversion, filtering, analog-to-digital conversion, digital-to-analog conversion, up-conversion, wireless LAN interface, frequency multiplexing, etc. In one embodiment, the radio transceiver interface 260 includes circuits to perform multi-channel single radio communication within the frequency ranges provided by the IEEE 802.11x standards (e.g., from 2.4 GHz to 5 GHz). This may include fast frequency switching or multiplexing circuit to change the frequencies while switching from one channel to the next channel within the frequency range. The frequency switching function may be implemented with advanced hardware to minimize the delays in tuning the radio operating parameters. The radio circuit may also include capabilities to listen on a certain frequency and gather interference or noise power level within a particular bandwidth. For example, three non-overlapping 22 Mhz channels are allocated for 802.11 radios at 2.4 GHz band in United States.

The antenna 280 may be any appropriate RF antenna for wireless communication. In one embodiment, the antenna 280 is the single antenna used for single radio operation. It is the only antenna attached to the device 110₂. It may be designed to accommodate the frequency ranges as provided by the IEEE 802.11x standards. The frequency range may be tuned to operate from 2.4 GHz to 5 GHz.

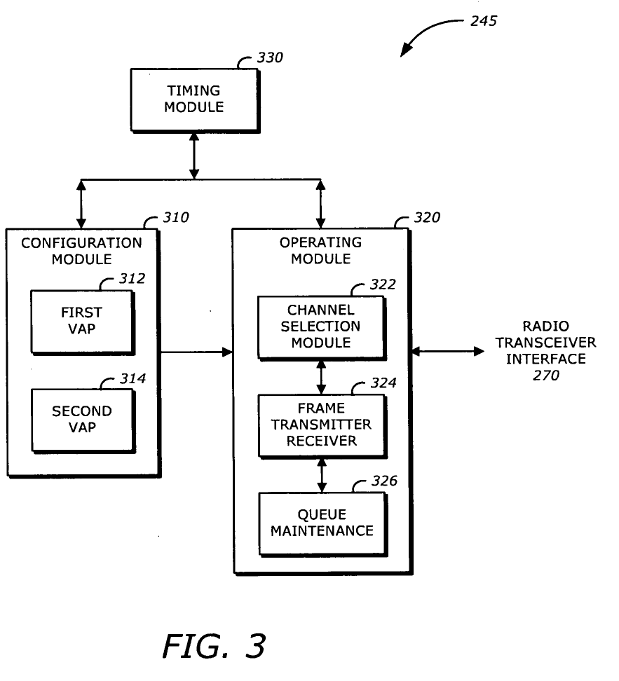

FIG. 3 is a diagram illustrating the single radio interface virtualizer 245 shown in FIG. 2 according to one embodiment. The single radio interface virtualizer 245 includes a configuration module 310, an operating module 320, and a timing module 330. It may include more or less than the above components. Any one of the above components may be implemented by hardware, software, firmware, or any combination thereof.

The configuration module 310 configures a physical network interface into a first virtual access point (VAP) 312 and a second VAP 314 on the device 110₂ using a single radio transceiver in the wireless home mesh network 100. The physical network interface may include the radio transceiver interface 260 and/or the antenna 270. For illustrative purposes, only two VAPs are used. It is contemplated that two or more than two VAPs may be realized depending on system requirements, complexity, network traffic, and other factors.

In one embodiment, the first VAP 312 operates on the first channel to handle mesh side traffic in accordance to a first protocol. The first protocol may include a mesh protocol using a standard ad hoc mode (e.g., an 802.11 ad hocmode) for operations in a driver layer below mesh layer. The second VAP 314 operates on the second channel to handle infrastructure side traffic in accordance to a second protocol. The second protocol uses a standard infrastructure mode (e.g., an 802.11 infrastructure mode) and communicates with the access point. The second VAP 314 may have two alternative infra modes. In the first infra mode, it may serve as an AP to tier-3 nodes or devices and other authorized non-mesh nodes or devices. In the second infra mode, it may act as a station device to directly connect to the tier-1 gateway, especially when the single radio device is within the frequency range of the tier-1 station. The beacon operation in each mode is different. In the ad hoc mode, each participant node competes for sending the beacon. In infra mode, the AP is the only node in the network that sends a beacon while the nodes in the station mode listen to the AP beacon and do not send a beacon. In each of the VAP slots, there is a small beacon slot. Depending on the VAP mode, a node may compete, send a beacon, or wait to hear a beacon from another node or AP. The beacon times for each VAP may be arranged so that they fall at the exact time a beacon is expected. For example, the 802.11 beacon interval (e.g., 100 ms) should be accurately considered.

In one embodiment, the configuration module 310 configures a physical network by sending a super frame that contains beacon information that is associated with the first and second VAPs 312 and 314. At the appropriate time, such as when triggered by the timing module 330, the configuration module 310 may interact with the radio transceiver interface 260 and/or execute a radio driver to generate a first Target Beacon Transition Time (TBTT) for the first VAP 312; and generate a second TBTT for the second VAP 314 if the second VAP operates in the first infra mode, or align a second TBTT with the TBTT generated by the tier-1 AP to listen to the tier-1 AP's beacon, if the second VAP operates in the second infra mode. In the second infra mode, a VAP operating in the station mode does not generate its own beacon. The beacon information generated or collected at each beacon interval allows one single physical radio to get the information from two different types of networks. Accordingly, the single radio may virtually perform different roles in the two networks.

The operating module 320 operates the first and second VAPs 312 and 314 on first and second channels, respectively, in a time division multiple access (TDMA) mode. The TDMA operation may be provided by the timing module 330. The first and second channels are different and correspond to different frequency bands in the operating frequency range of the radio transceiver interface 260 and/or the antenna 270. In the TDMA mode, each VAP is allocated or assigned a dedicated or pre-determined time slot to transmit and receive data. The amount of time slot for each VAP depends on the estimated traffic load. For example, the mesh side time slot is assigned with consideration for mesh traffic between the tier-2 nodes and the infra side time slot is assigned with consideration for infra traffic between the tier-3 and non-mesh nodes or devices.

The operating module 320 may include a channel selection module 322, a frame transmitter/receiver 324, and a queue maintenance module 326. The channel selection module 322 selects the channel for transmission as appropriate. It may include a switching mechanism to switch to the appropriate channel according to the VAP that is operating. As part of the time multiplexing scheme in the TDMA mode as provided by the timing module 330, the frame transmitter/receiver 324 transmits or receives the frames by alternately switching back and forth the two assigned time slots for the two VAPs. It may transmit or receive a frame via the first VAP 312 or the second VAP 314 in first or second assigned time slots on the first or second channels in accordance to the first protocol or the second protocol, respectively. In one embodiment, since different channels are used, when the single radio operates as the first VAP 312 for relaying mesh side traffic data, it may not be available for access for non-mesh or tier-3 devices or stations. To prevent these non-mesh or tier-3 devices or stations from making futile re-transmissions according to the 802.11 standard during the first AP mode, the operating module 320 may suspend the frame transmissions on the client devices or stations during the time the single radio is operating as the first VAP 312. The suspension may be achieved by any suitable technique to inform the client devices or stations that there will be no transmissions. For example, this may achieved by appropriately setting the Network Allocation Vector (NAV) defined in the 802.11 standard at the end of the time slot when the single radio is operating as the second VAP 312.

The queue maintenance module 324 helps streamlining the handling the packets from two different types of traffic/networks. It may maintain an efficient queue mechanism that processes the in-coming or out-going packets with high throughput and reduced packet loss probability. The queue mechanism may have a dispatcher for controlling in-bound and out-bound flows of traffic via the first and second VAPs 312 and 314.

The timing module 330 provides timing information to various modules in the single radio virtualizer 245. It manages the generation of timing signals in accordance to the TDMA mode. For example, it may generate a timing signal to indicate the start of the configuration or operation of the first or second VAP. It may generate timing signals corresponding to the first and second time slots for the first and second VAPs.

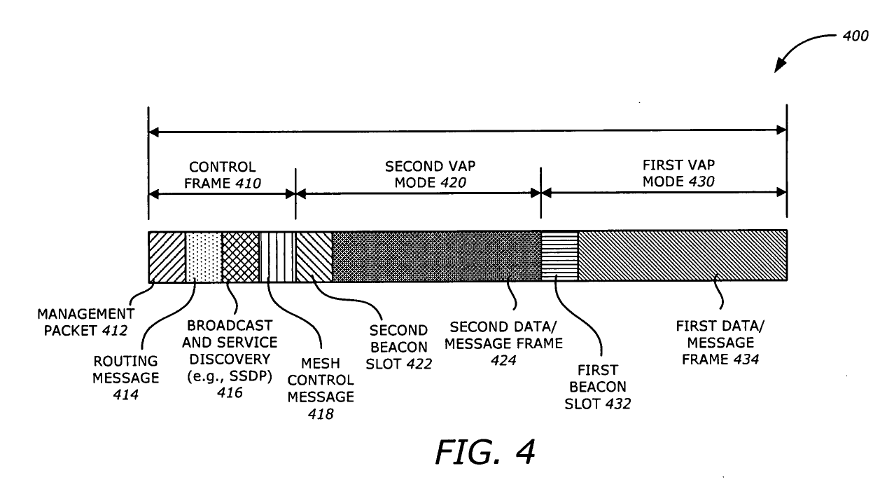

FIG. 4 is a diagram illustrating a super frame 400 according to one embodiment. The super frame 400 may include three frames or fields: a control frame 410, a second VAP mode frame 420, and a first VAP mode frame 430. The super frame 400 may include more or less than the above frames or fields. The super frame 400 may be transmitted by the virtualizer 245 according to the underlying protocol standard (e.g., an 802.11 standard).

The control frame 410 includes control, synchronization, timing, discovery, and other control messages. It may include several sub-frames for management packet 412, a routing message 414, a broadcast and discovery message 416, and a mesh control message 418. The management packet 412 conforms to an 802.11 standard. The routing message 414 may include messages to maintain a healthy route between nodes such as hello, router request, and route reply. The broadcast and discovery message 416 may include any messages used for discovery, authentication, or association such as Simple Service Discovery Protocol (SSDP). The mesh control message 418 may include any messages used for control and management functions for the mesh network.

The first and second VAP mode frames 430 and 420 may include any messages that belong to the networks handled by the first and second VAPs 312 and 314, respectively. In other words, the first VAP mode frame 430 may be used by the first VAP 312 when the single radio operates in the first VAP mode (e.g., mesh side traffic) and the second VAP mode frame 420 may be used by the second VAP 314 when the single radio operates in the second VAP mode (e.g., infrastructure side traffic). The first VAP mode frame 430 may include a first beacon slot 432 and a first data/message frame 434. The second VAP mode frame 420 may include a second beacon slot 422 and a second data/message frame 424. The first and second beacon slots 432 and 422 are used to transmit the beacon in the first and second VAP modes, respectively. The first and second data/message frames 434 and 424 are used to transmit data or messages in the first and second VAP modes, respectively.

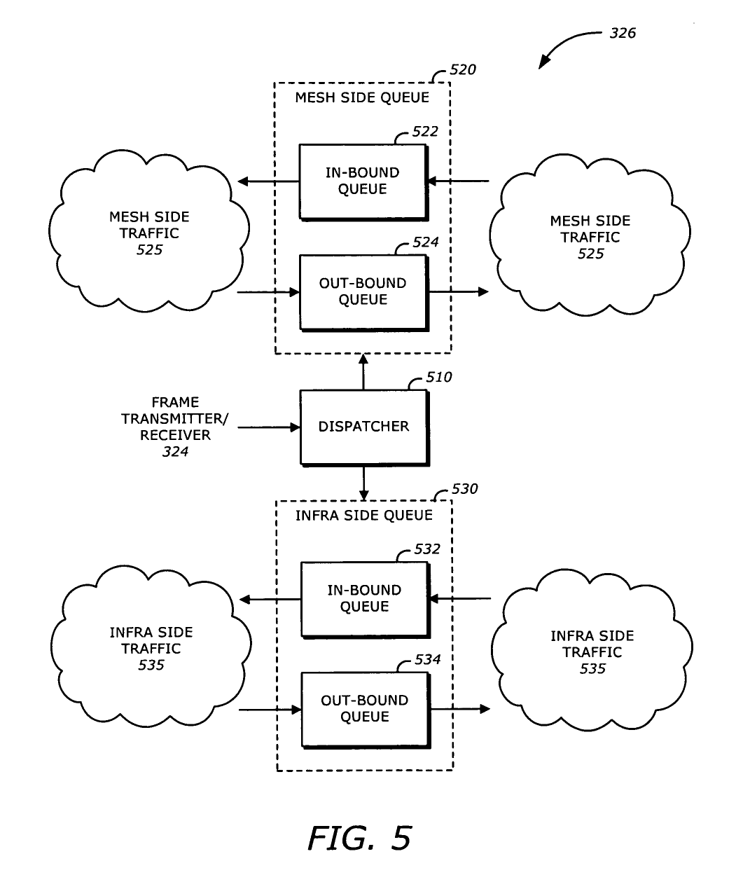

FIG. 5 is a diagram illustrating the queue maintenance module 324 shown in FIG. 3 according to one embodiment. The queue maintenance module 324 includes a dispatcher 510, a mesh side queue 520, and an infra side queue 530. The queue maintenance module 324 may include more or less than the above components. Any one of the above components may be implemented by hardware, software, firmware, or any combination thereof.

The dispatcher 510 interfaces with the frame transmitter/receiver 322 to transmit or receive a frame. It may operate in a pipelined or parallel manner with the frame transmitter/receiver 322 to enhance the overall throughput. It may have a fast switching mechanism to switch between the mesh side queue 520 and the infra side queue 530 when operating in the first VAP mode and the second VAP mode, respectively.

The mesh side queue 520 contains buffers or queues to store packets from the mesh side traffic 525. It may have an in-bound queue 522 and an out-bound queue 524 to store received frames and transmitted frames from or to the mesh side traffic 525, respectively. The queue size or sizes may be selected to minimize packet loss. Similarly, the infra side queue 530 contains buffers or queues to store packets from the infra side traffic 535. It may have an in-bound queue 532 and an out-bound queue 534 to store received frames and transmitted frames from or to the infra side traffic 535, respectively. The queue size or sizes may be selected to minimize packet loss. For clarity, the mesh side traffic 525 and the infra side traffic 535 are shown to be associated with the corresponding queues. It is noted that there are traffics between the mesh and non-mesh virtual interfaces as well.

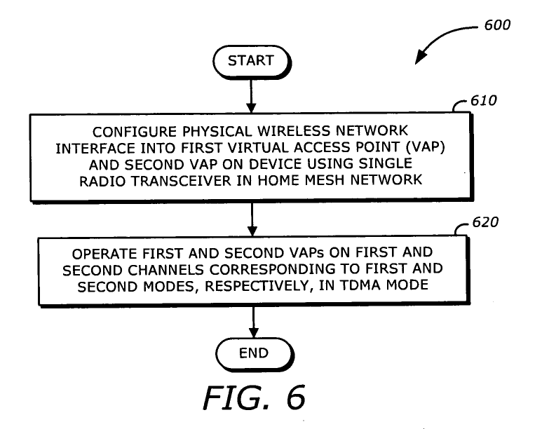

FIG. 6 is a flowchart illustrating a process 600 to virtualize a single radio for multiple interfaces according to one embodiment.

Upon START, the process 600 configures a physical wireless network interface into a first virtual access point (VAP) and a second VAP on a device using a single radio transceiver in a home mesh network (Block 610). Next, the process 600 operates the first and second VAPs on first and second channels corresponding to first and second modes, respectively, in a time division multiple access (TDMA) mode (Block 620). Based on the implementation and particular network, the first and second channels may be the same or different. Similarly, the first and second modes may be the same or different. The process 600 is then terminated.

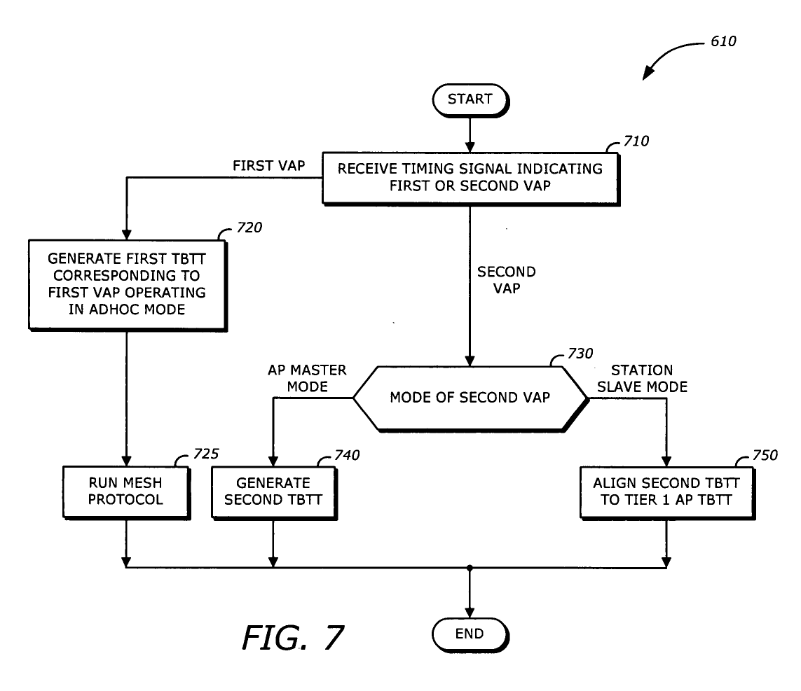

FIG. 7 is a flowchart illustrating the process 610 shown in FIG. 6 to configure a physical wireless network interface according to one embodiment.

Upon START, the process 610 receives a timing signal indicating first or second VAP (Block 710). If the timing signal indicates the first VAP, the process 610 generates a first target beacon transmission time (TBTT) corresponding to the first VAP operating in an ad hoc mode (Block 720). The ad hoc mode is the mode in which the VAP handles the mesh side traffic. The process 610 then runs the mesh protocol (Block 725) and is then terminated. If the timing signal indicates the second VAP, the process 610 determines the mode of the second VAP (Block 730). If it is the first infra mode, the process 610 generates a second TBTT (Block 740). In one embodiment, the first infra mode is the AP master mode. This corresponds to the second VAP if the second VAP operates in an access point (AP) mode. If it is the second infra mode, the process 610 aligns the second TBTT to a tier-1 AP TBTT (Block 750). In one embodiment, the second infra mode is the station slave mode. This corresponds to the second VAP if the second VAP operates in a station mode. The process 610 is then terminated.

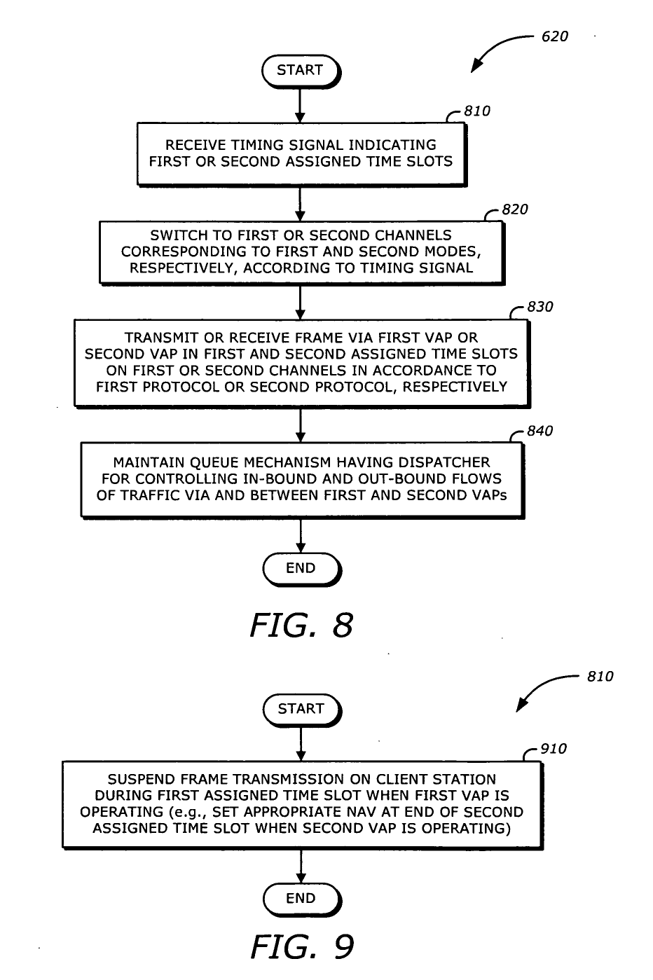

FIG. 8 is a flowchart illustrating the process 620 shown in FIG. 6 to operate first and second virtual access points (VAP) according to one embodiment.

Upon START, the process 620 receives a timing signal indicating first or second assigned time slots (Block 810). The timing signal may be provided by the timing module 330 shown in FIG. 3. The first and second assigned time slots correspond to the first and second VAPs. Next, the process 620 switches to the first or second channels corresponding to the first and second modes according to the timing signal (Block 820). The channel switching may be performed by the channel selection module 322 shown in FIG. 3. Then, the process 620 transmits or receives a frame via the first VAP or the second VAP in the first and second assigned time slots on the first or second channels in accordance to a first protocol or a second protocol, respectively (Block 830). Based on a particular implementation or scenario, the first and second channels may be different corresponding to different networks.

Next, the process 620 maintains a queue mechanism having a dispatcher for controlling in-bound and out-bound flows of traffic via and between the first and second VAPs (Block 840). The process 620 is then terminated.

FIG. 9 is a flowchart illustrating the process 810 shown in FIG. 8 to transmit or receive a frame according to one embodiment.

Upon START, the process 810 suspends frame transmission on a client station during the first assigned time slot when the first VAP is operating (Block 910). This may be done by, for example, setting an appropriate standard 802.11 network allocation vector (NAV) at end of the second assigned time slot when the second VAP is operating. The process 810 is then terminated.

Elements of one embodiment may be implemented by hardware, firmware, software or any combination thereof. The term hardware generally refers to an element having a physical structure such as electronic, electromagnetic, optical, electro-optical, mechanical, electromechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store or transfer information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical storage medium, a magnetic storage medium, a memory stick, a memory card, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
configuring a physical wireless network interface into a first virtual access point (VAP) and a second VAP on a device using a single radio transceiver in a home mesh network; and
operating the first and second VAPs on first and second channels corresponding to first and second modes, respectively, in a time division multiple access (TDMA) mode.

2. The method of claim 1 wherein configuring the physical network interface comprises:
receiving a timing signal indicating the first or second VAP;
if the timing signal indicates the first VAP, generating a first target beacon transmission time (TBTT) corresponding to the first VAP operating in an ad hoc mode;
if the timing signal indicates the second VAP and the second VAP operates in an access point (AP) mode, generating a second TBTT corresponding to the second VAP; and
if the timing signal indicates the second VAP and the second VAP operates in a station mode, aligning the second TBTT to a tier-1 AP TBTT corresponding to the second VAP.

3. The method of claim 1 wherein operating the first and second VAPs comprises:
receiving a timing signal indicating first or second assigned time slots;
switching to the first or second channel corresponding to the first and second modes according to the timing signal;
transmitting or receiving a frame via the first VAP or the second VAP in the first and second assigned time slots on the first or second channels in accordance to a first protocol or a second protocol, respectively; and
maintaining a queue mechanism having a dispatcher for controlling in-bound and out-bound flows of traffic via and between the first and second VAPs.

4. The method of claim 3 wherein the first VAP operates on the first channel to handle mesh side traffic in accordance to the first protocol.

5. The method of claim 4 wherein the first protocol comprises a mesh protocol operating in a standard ad hoc mode for operations in a driver layer below mesh layer.

6. The method of claim 3 wherein the second VAP operates on the second channel to handle infrastructure side traffic in accordance to the second protocol.

7. The method of claim 6 wherein the second protocol comprises a standard infrastructure mode of operation.

8. The method of claim 3 wherein transmitting or receiving a frame comprises:
suspending frame transmission on a client station during the first assigned time slot when the first VAP is operating.

9. The method of claim 8 wherein suspending the frame transmission comprises:
setting an appropriate 802.11 network allocation vector (NAV) at end of the second assigned time slot when the second VAP is operating.

10. The method of claim 1 wherein the wireless home mesh network conforms to an 802.11 standard.

11. An article of manufacture comprising:
a machine-accessible storage medium including data that, when accessed by a machine, cause the machine to perform operations comprising:
configuring a physical wireless network interface into a first virtual access point (VAP) and a second VAP on a device using a single radio transceiver in a home mesh network; and
operating the first and second VAPs on first and second channels corresponding to first and second modes, respectively, in a time division multiple access (TDMA) mode.

12. The article of manufacture of claim 11 wherein the data causing the machine to perform configuring the physical network interface comprise data that, when accessed by the machine, cause the machine to perform operations comprising:
receiving a timing signal indicating the first or second VAP;
if the timing signal indicates the first VAP, generating a first target beacon transmission time (TBTT) corresponding to the first VAP operating in an ad hoc mode;
if the timing signal indicates the second VAP and the second VAP operates in an access point (AP) mode, generating a second TBTT corresponding to the second VAP and
if the timing signal indicates the second VAP and the second VAP operates in a station mode, aligning the second TBTT to a tier-1 AP TBTT corresponding to the second VAP.

13. The article of manufacture of claim 11 wherein the data causing the machine to perform operating the first and second VAPs comprise data that, when accessed by the machine, cause the machine to perform operations comprising:
receiving a timing signal indicating first or second assigned time slots;
switching to the first or second channel corresponding to the first and second modes according to the timing signal;
transmitting or receiving a frame via the first VAP or the second VAP in the first and second assigned time slots on the first or second channels in accordance to a first protocol or a second protocol, respectively; and
maintaining a queue mechanism having a dispatcher for controlling in-bound and out-bound flows of traffic via and between the first and second VAPs.

14. The article of manufacture of claim 13 wherein the first VAP operates on the first channel to handle mesh side traffic in accordance to the first protocol.

15. The article of manufacture of claim 14 wherein the first protocol comprises a mesh protocol operating in a standard ad hoc mode for operations in a driver layer below mesh layer.

16. The article of manufacture of claim 13 wherein the second VAP operates on the second channel to handle infrastructure side traffic in accordance to the second protocol.

17. The article of manufacture of claim 16 wherein the second protocol comprises a standard infrastructure mode of operation.

18. The article of manufacture of claim 13 wherein the data causing the machine to perform transmitting or receiving a frame comprise data that, when accessed by the machine, cause the machine to perform operations comprising:
suspending frame transmission on a client station during the first assigned time slot when the first VAP is operating.

19. The article of manufacture of claim 18 wherein the data causing the machine to perform suspending the frame transmission comprise data that, when accessed by the machine, cause the machine to perform operations comprising:
setting an appropriate 802.11 network allocation vector (NAV) at end of the second assigned time slot when the second VAP is operating.

20. The article of manufacture of claim 1 wherein the wireless home mesh network conforms to an 802.11 standard.

21. An apparatus comprising:
a radio frequency (RF) tunable antenna;
a single radio transceiver interface operating at a radio frequency to communicate with a plurality of network devices in a wireless mesh home network; and
an access point (AP) virtualizer coupled to the single radio transceiver interface, comprising:
a configuration module to configure a physical wireless network interface into a first virtual access point (VAP) and a second VAP, and
an operating module coupled to the configuration module to operate the first and second VAPs on first and second channels corresponding to first and second modes, respectively, in a time division multiple access (TDMA) mode.

22. The apparatus of claim 21 wherein the configuration module receives a timing signal indicating the first or second VAP, generates a first target beacon transmission time (TBTT) corresponding to the first VAP operating in an ad hoc mode if the timing signal indicates the first VAP, generates a second TBTT corresponding to the second VAP if the timing signal indicates the second VAP and the second VAP operates in an access point (AP) mode, and aligns the second TBTT to a tier-1 AP TBTT corresponding to the second VAP if the timing signal indicates the second VAP and the second VAP operates in a station mode.

23. The apparatus of claim 21 wherein the operating module comprises:
a channel selection module to switch to the first or second channels corresponding to the first and second modes according to a timing signal that indicates first or second assigned time slots, respectively;
a frame transmitter and receiver to transmit or receive a frame via the first VAP or the second VAP in the first and second assigned time slots on the first or second channels in accordance to a first protocol or a second protocol, respectively; and
a queue maintenance module coupled to the frame transmitter and receiver to maintain a queue mechanism having a dispatcher for controlling in-bound and out-bound flows of traffic via and between the first and second VAPs.

24. The apparatus of claim 23 wherein the first VAP operates on the first channel to handle mesh side traffic in accordance to the first protocol.

25. The apparatus of claim 24 wherein the first protocol comprises a mesh protocol operating in a standard ad hoc mode for operations in a driver layer below mesh layer.

26. The apparatus of claim 23 wherein the second VAP operates on the second channel to handle infrastructure side traffic in accordance to the second protocol.

27. The apparatus of claim 26 wherein the second protocol comprises a standard infrastructure mode of operation.

28. The apparatus of claim 23 wherein the frame transmitter and receiver suspends frame transmission on a client station during the first assigned time slot when the first VAP is operating.

29. The apparatus of claim 28 wherein the frame transmitter and receiver suspends frame transmission by setting an appropriate 802.11 network allocation vector (NAV) at end of the second assigned time slot when the second VAP is operating.

30. The apparatus of claim 1 wherein the wireless home mesh network conforms to an 802.11 standard.
